(19) United States
(12) Patent Application Publication
(10) Pub. No.: US 2012/0212363 A1
(43) Pub. Date: Aug. 23, 2012

(54) Method and device for neutralizing a target

(75) Inventors: Jean-Pierre Brasile, Gif Sur Yvette (FR); Dominique Fasse, Breancon (FR); Patrick Sirot, La Teste De Buch (FR); Dominique Jousse, Fresnes (FR)

(73) Assignee: THALES, Neuilly Sur Seine (FR)

(21) Appl. No.: 13/337,826

(22) Filed: Dec. 27, 2011

(30) Foreign Application Priority Data
Dec. 29, 2010 (FR) 1005160

(51) Int. Cl. G01S 7/42

(52) U.S. Cl. 342/14

(57) ABSTRACT

A method for remotely neutralizing a target. The method includes transmission by a probe antenna toward the target of a test signal having a frequency spectrum having at least two distinct test frequencies; reception by an array of at least two antennas of a plurality of waves scattered by the target in response to the test signal. For each antenna of the array the method includes measuring a representative value of the amplitude of the waves scattered by the target as a function of the test frequencies; choosing at least one favored transmission frequency as a function of the representative value of the amplitude of the scattered waves; and transmitting at least one radiofrequency wave toward the target at a minimum of one favored frequency chosen for that antenna with a phase ensuring the coherent addition on the target of the radiofrequency waves transmitted by the antennas of the array.

### BACKGROUND

The present invention relates to a method for remotely neutralizing a target and the associated device. The target neutralization method comprises the following steps:
the transmission by a probe antenna toward the target of a test signal comprising at least one test radiofrequency wave and having a frequency spectrum comprising at least two distinct test frequencies; and
reception by an array of at least two antennas of a plurality of waves scattered by the target in response to the test signal, each antenna of the array receiving at least one wave scattered by the target.

More particularly, the invention relates to the field of hyperfrequency weapons and interfering transmitters applied to the remote disruption or destruction of electronic equipment, in particular weapon systems or explosive devices.

To that end, it is crucial to choose the frequencies of the waves transmitted to the target correctly so that the latter picks up the greatest possible amount of energy from the waves it receives to disrupt it. Unless very heavy methods are implemented for the purpose of transmitting very high powers over a wide frequency band, “blind” transmissions generally do not make it possible to noticeably disrupt the operation of the target. One solution is to transmit waves at a minimum of one resonance frequency of the target. However, the excitation of the resonance frequencies of the target depends on many parameters, such as the relative orientation between the target and the transmitter of the transmitted radiofrequency waves.

Known in particular from document WO 2007/59508 is a method for neutralizing a target, comprising a step for transmitting a broadband signal on the target by a transmitter and a step for receiving signals retransmitted by the target by several receivers. The received signals are then time reversed and sent back by several high-power transmitters toward the target. This method makes it possible to transmit a wave whereof the waveform obtained by time reversal is optimized for a given position of the target.

Nevertheless, time reversal methods are complex and require substantial computation means.

The aim of the invention is to provide a method for neutralizing a target remotely that is both effective and free from complex and expensive signal processing in terms of computation time.

To that end, the invention relates to a method for neutralizing a target of the aforementioned type, characterized in that it comprises at least the following steps:
measuring a representative value of the amplitude of the waves scattered by the target as a function of the transmission test frequencies of the radiofrequency waves;
choosing, for each antenna of the array, at least one favored transmission frequency as a function of the representative value of the amplitude of the scattered waves; and
transmitting, by each antenna of the array, at least one radiofrequency wave toward the target at a minimum of one favored frequency chosen beforehand for that antenna with a phase ensuring the coherent addition on the target of the radiofrequency waves transmitted by the antennas of the array.

According to specific embodiments, the method for neutralizing the target comprises one or more of the following features, considered alone or in combination:
a measuring step for each antenna of the array receiving a scattered radiofrequency wave, to measure the travel time of the scattered radiofrequency wave between the target and the antenna of the array;
each antenna of the array is synchronized with the probe antenna and in that it transmits, toward the target, the radiofrequency wave at a moment defined as a function of the measured travel time of the scattered radiofrequency wave between the target and the antenna of the array;
a step for transmission by the probe antenna of a synchronization signal and a step for reception of that synchronization signal by each antenna of the array, which synchronizes itself on said synchronization signal;
the selected favored transmission frequency or frequencies are those whereof the representative value of the amplitude is the highest among the scattered radiofrequency waves received by all of the antennas in the array and in that the or each selected frequency for the transmission of a radiofrequency wave by the antennas of the array are shared by all of the antennas of the array;
the selected favored transmission frequency or frequencies for the antenna are those whereof the value representative of the amplitude is highest among the scattered radiofrequency waves for each antenna of the array;
the selected favored transmission frequency or frequencies are those that meet the expectation of the maximum of a predetermined function depending on the values representative of the amplitude of the waves scattered by the target for several frequency combinations; and
the predetermined function depends on the travel time of the scattered radiofrequency wave between the target and the antenna of the array.

The invention also relates to a device for neutralizing a target comprising:
a probe antenna, adapted to transmit, toward the target, a test signal comprising at least one test radiofrequency wave and having a frequency spectrum comprising at least two distinct test frequencies,
an array of at least two antennas, each adapted to receive at least one radiofrequency wave scattered by the target in response to the test signal and to transmit at least one radiofrequency wave toward the target,

the device being characterized in that:
each antenna of the array comprises means for measuring the value representative of the amplitude of the waves scattered by the target as a function of the transmission test frequencies of the radiofrequency wave;
the device comprises a unit for selecting at least one favored transmission frequency, for each antenna of the array, as a function of the value representative of the amplitude of the scattered waves;
each antenna of the array is capable of transmitting a radiofrequency wave toward the target at a minimum of one favored frequency chosen beforehand for that antenna with a phase ensuring the coherent addition on the target of the radiofrequency waves transmitted by the antennas of the array;
the device being adapted to implement the aforementioned method.

According to one particular embodiment, the neutralization device comprises the following feature: the antenna array comprises the probe antenna, the probe antenna being adapted to receive a radiofrequency wave scattered by the target.

### BRIEF DESCRIPTION OF THE DRAWINGS

The invention will be better understood upon reading the following description, provided solely as an example, and done in reference to the drawings, in which:

FIG. 1 is a summary diagram illustrating one embodiment of a device for neutralizing a target according to the invention, and

FIG. 2 is a block diagram illustrating the neutralization method implemented by the device of FIG. 1.

The invention relates to a method for neutralizing a target remotely and the associated device. The purpose of such a method is to neutralize systems comprising electronic components.

In fact, it is known that the operation of electronic components subject to strong electromagnetic transmissions can be disrupted. In particular, for a given frequency, an electromagnetic wave sent onto the target creates a particular coupling with the target, due to the configuration of the latter and in particular the presence of electrical cables, the arrangement of openings favorable to the propagation of certain wavelengths, the nature of the materials and components integrated into the target. The optimal coupling frequency is that for which the wave best penetrates the target, that which allows significant coupling with the cables and/or with sensitive electronic components.

To that end, the method according to the invention aims to identify the most effective frequencies (resonance, harmonic detection) and transmit them in frequency coherence.

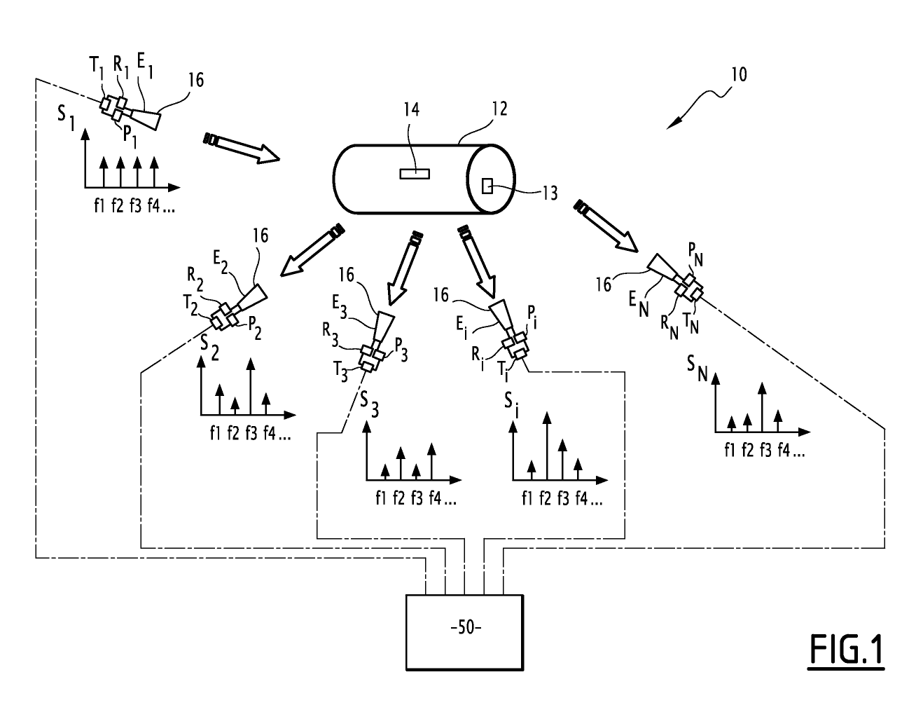

FIG. 1 illustrates one embodiment according to the invention of a device 10 for neutralizing a target 12 comprising at least one active electronic component 13 and an opening 14.

The device 10 comprises several antennas designated by general reference Eᵢ, with i an integer comprised between 1 and N. This plurality of antennas forms a sparse antenna array, also called sparse antenna.

One of the antennas is particularly adapted to transmit, toward the signal, a test radiofrequency signal having a frequency spectrum comprising at least two distinct frequencies and comprising at least one radiofrequency wave. Hereafter, that antenna is called probe antenna 16.

For example, the probe antenna transmits a test signal comprising a single radiofrequency wave having a spectrum comprising at least two distinct frequencies.

In another example, the probe antenna transmits a test signal comprising several successive radiofrequency waves, each of said radiofrequency waves being either mono-frequency or having a spectrum comprising at least two distinct frequencies.

The antennas Eᵢ of the sparse array each comprise a receiver Rᵢ capable of receiving a radiofrequency wave scattered by the target and a transmitter Pᵢ capable of transmitting a radiofrequency wave toward the target.

Furthermore, each antenna Eᵢ of the sparse array comprises processing means Tᵢ for the radiofrequency waves transmitted by the target, connected to the transmitter Pᵢ and the receiver Rᵢ of the antenna.

These processing means Tᵢ comprise means for measuring the amplitude of the waves scattered by the target as a function of the transmission frequencies of the radiofrequency wave transmitted by the probe antenna 16, or any other value representative of the amplitude, such as the instantaneous power or the intensity.

Furthermore, the processing means Tᵢ comprise means for measuring the travel time tᵢ of the scattered radiofrequency waves between the target and the antenna Eᵢ of the array as a function of the transmission frequencies of the radiofrequency wave, or any other value representative of the travel time tᵢ such as the phase of the radiofrequency waves scattered by the target and received by each antenna Eᵢ of the array.

Lastly, the device 10 comprises a unit 50 for selecting at least one favored transmission frequency as a function of the amplitude and the travel time tᵢ of the scattered waves received by each of the antennas Eᵢ. This unit 50 comprises means for assigning each transmitter Pᵢ of each antenna Eᵢ a set of favored transmission frequencies that may be specific to each antenna Eᵢ.

The unit 50 is also capable of providing the probe antenna 16 with a set of test frequencies able to be implemented in a test radiofrequency signal initially sent to the target 12.

According to an alternative embodiment, the probe antenna is independent of the sparse array.

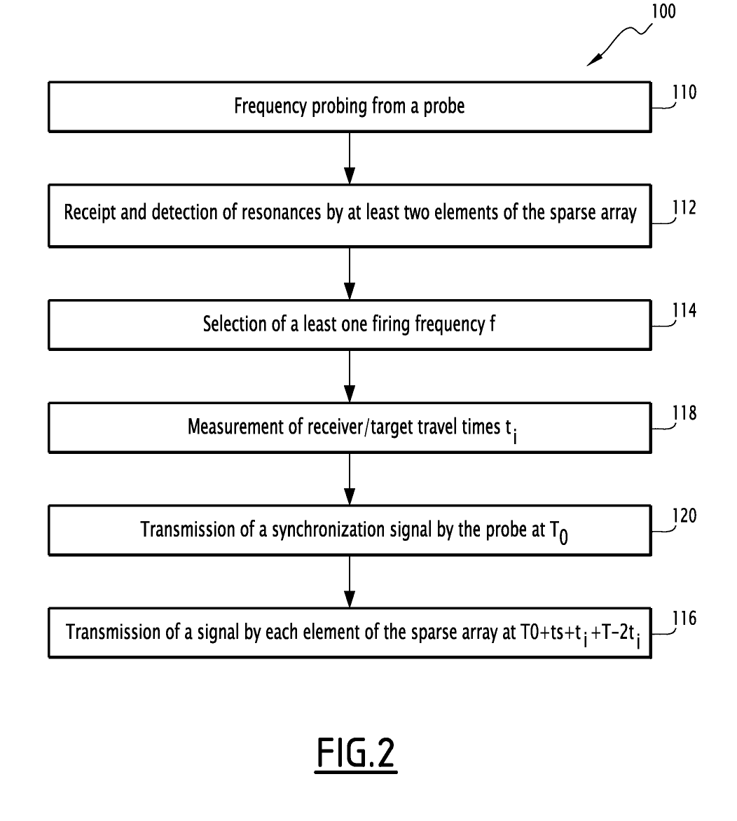

The device 10 is adapted to implement the neutralization method 100 according to the invention, which will now be described in reference to FIG. 2.

During step 110, the probe antenna 16 transmits a test radiofrequency signal toward the target. This radiofrequency signal has a frequency spectrum comprising at least two different frequencies so as to access an optimal coupling with the target, the effective section of which varies greatly with the frequency.

For example, this signal is the signal having a broadband frequency spectrum, with a width of at least 100 MHz.

According to another example, this signal is a radiofrequency wave train, each wave having a narrow frequency spectrum, in the vicinity of 10 to 100 kHz.

Preferably, the frequency spectrum of the transmitted signal is in a range of 1 to 5 GHz.

Then, for a certain number of so-called favored frequencies, the test radiofrequency signal sent to the target 12 creates a particular coupling with the target, due to the configuration thereof, for example the arrangement of openings 14 favorable to the propagation of certain wavelengths, thereby improving the penetration of the signal in the target.

Radiofrequency waves are then scattered by the target 12 in several directions. For example, they are directly reflected on the target or after penetration through the openings 14 of the target. These openings, when excited by a wave at the resonance frequency of the target, behave like antennas radiating a radiofrequency signal amplified by the resonance in all directions, in particular toward the inside of the target and toward the antennas Eᵢ of the array.

The amplitude of the scattered radiofrequency waves depends on the radiofrequency signal received by the target and the resonance thereof, i.e. the favored frequencies creating optimal coupling.

They are received by the receivers Rᵢ of at least two antennas of the sparse array during step 112. The processing means Tᵢ of the signals scattered by the target and received by the receivers Rᵢ analyze those signals in order to detect the resonance frequencies of the target, i.e. the favored frequencies.

To that end, the processing means Tᵢ analyze the frequency spectrum of the received signals and identify the frequencies with the largest amplitude corresponding to the frequencies for which a particular coupling has taken place between the target and the radiofrequency wave received by the target.

Each receiver Rᵢ receives a signal scattered by the target having a frequency spectrum comprising the frequencies of the test radiofrequency wave and, if applicable, their higher-order harmonics, i.e. the multiples of those frequencies when the test radiofrequency wave is detected by a nonlinear element of the target, in particular by the electronic component 13.

One example of frequency spectrum of the signals received by the receivers is illustrated in FIG. 1. In this example, the radiofrequency wave transmitted toward the target has a frequency spectrum comprising four frequencies f₁, f₂, f₃ and f₄ of the same intensity or amplitude.

Furthermore, the received signal at frequency f₃ has a larger amplitude relative to the signals received at frequencies f₂ or f₄ on the receivers R₂ and R₄, while on the receiver R₃, the signals received at frequencies f₂ and f₄ have the largest amplitudes.

During step 114, at least one favored transmission frequency is chosen for each antenna Eᵢ as a function of the amplitude of the scattered waves received by each antenna Eᵢ. This step is implemented by the selection unit 50.

A radiofrequency wave is then transmitted by each antenna Eᵢ of the array toward the target at a minimum of one frequency chosen among the favored transmission frequencies selected beforehand during step 116 so as to perform a coherent addition on the target of the radiofrequency waves transmitted by the antennas Eᵢ of the array.

The selected favored transmission frequency or frequencies are those to which the highest amplitude of the scattered radiofrequency waves for all of the antennas Eᵢ of the array corresponds. In that case, the or each frequency selected for the transmission of a radiofrequency wave by the antennas Eᵢ of the array are shared by all of the antennas Eᵢ of the antenna array.

For example, a single frequency is selected to transmit a radiofrequency wave for each transmitter Pᵢ of an antenna Eᵢ of the sparse array. In that case, the set of antennas Eᵢ of the array then transmit, in coherence of frequency, a signal at the selected frequency toward the target.

For the example of frequency spectrums of the radiofrequency waves received by the antennas Eᵢ of the array illustrated in FIG. 1, the frequency f₃ has the largest amplitude for a majority of the antennas Eᵢ of the sparse array. In that case, each transmitter Pᵢ of the antennas Eᵢ of the array transmits, in frequency coherence, a wave at the selected frequency f₃. Nevertheless, the frequency f₃ having a low amplitude for the antenna E₃, it is preferable to favor the transmission for that antenna E₃ of a wave at the frequency f₄ that has a larger amplitude.

A high amplitude of a frequency in the frequency spectrums of the signals received by the entire sparse array is characteristic of a resonance of the target, while a low level on one of the receivers Rᵢ of the antennas Eᵢ of the array is characteristic of an unfavorable scattered direction. This unfavorable scattering direction is then unfavorable in case of transmission at that frequency for the antenna Eᵢ in the considered orientation of the target. As a result, it is therefore not particularly advisable to transmit a wave at that frequency for the considered antenna. In that case, that antenna Eᵢ transmits a wave at a frequency that has a larger amplitude for that antenna Eᵢ.

According to a first alternative, the selected favored transmission frequency or frequencies are those to which the highest amplitude of the scattered radiofrequency waves for each antenna of the array corresponds.

In that case, each transmitter of the antenna array transmits a radiofrequency wave toward the target at the frequency having the largest amplitude in the frequency spectrum of the radiofrequency signal retransmitted by scattering by the target and received by the receiver Rᵢ of the antenna Eᵢ of the array.

For the example illustrated in FIG. 1, the frequency fₑ has the largest amplitude for the antennas of the array E₂ and E_{N}. For the antennas of the array E₃ and Eᵢ, these are frequencies f₄ and f₂, respectively. In that case, the transmitters of the antennas of the array E₂, E₃, Eᵢ and E_{N} respectively transmit a wave at the selected frequency f₃, f₄, f₂, f₃.

According to a third alternative, a set of frequencies is chosen by the selection unit 50 and the signal transmitted by each transmitter Pᵢ of the sparse array has a frequency spectrum comprising the frequencies of the selected set.

For example, the signal comprises several mono-frequency waves, each being transmitted at a frequency of the selected set of frequencies. Each transmitter Pᵢ of the antennas Eᵢ of the array transmits, in coherence of frequency, the mono-frequency waves successively.

In the case of frequency spectrums of the radiofrequency waves received by the antennas Eᵢ of the array illustrated in FIG. 1, the frequencies f₂ and f₃ have the largest amplitudes on average for the set of antennas Eᵢ of the sparse array. In that case, each transmitter Pᵢ of the antennas Eᵢ of the array transmits, in coherence of frequency, a mono-frequency wave at the two selected frequencies f₂ and f₃ successively.

According to another example, the signal comprises a transmitted wave that is then the sum of several mono-frequency waves, each having a frequency among the selected frequency set. The amplitude of the mono-frequency waves in the transmitted radiofrequency wave is weighted as a function of the amplitude of their frequency in the frequency spectrum of the radiofrequency signals received by the set of antennas Eᵢ of the array.

According to a fourth alternative, the selected favored transmission frequency or frequencies are those that meet the expectation of the maximum of a predetermined function depending on the values representative of the amplitude of the waves scattered by the target 12 for several frequency combinations.

For example, the test radiofrequency wave has a frequency spectrum comprising two frequencies f₁ and f₂. Each receiver Rᵢ receives one of the radiofrequency waves scattered by the target in response to the test radiofrequency wave. The values representative the amplitude of those scattered waves on each receiver Rᵢ are denoted Uᵢ₁ and Uᵢ₂ for frequencies f₁ and f₂. The selection unit 50 computes, for each frequency f₁ and f₂, a predetermined function

$$G ( {f}_{j} ) = {\sum }_{i}^{ } {g}_{i} \times {U}_{ij}$$

where gᵢ is a predetermined weight coefficient of the frequency fᵢ. The favored transmission frequency chosen for the set of antennas Eᵢ of the array is the frequency for which the function G is maximal. In particular, this function favors the frequencies allowing the detection of harmonics, which, even at very low levels, correspond to frequencies having had an effect on the electronics integrated into the target.

The different possible alternatives are not mutually exclusive. Advantageously, waves are transmitted successively toward the target at frequencies chosen according to all or part of the possible alternatives.

In order to perform the coherent addition on the target of the radiofrequency waves transmitted by the antennas of the array, a measuring step 118 is carried out for each antenna Eᵢ of the array receiving a scattered radiofrequency wave from the travel time tᵢ of the scattered radiofrequency wave between the target and the antenna Eᵢ of the array.

To that end, each antenna Eᵢ of the array transmits a signal comprising at least one wave. The frequency spectrum of that signal comprises at least one selected favored transmission frequency. Then, the travel times tᵢ(f) of the signal for each selected favored transmission frequency f are measured by the processing means Tᵢ for example, by measuring the phase of the waves scattered by the target as a function of the transmission frequencies of the radiofrequency wave transmitted by the antenna Eᵢ.

Lastly, the antennas of the array transmit a signal comprising at least one radiofrequency wave toward the target at the moment anticipating the arrival moment of the or each wave, each having a selected favored transmission frequency, on the expected target with a duration equal to tᵢ(f)/c where c is the speed of the wave.

This step 118 is carried out after step 114 for choosing at least one favored frequency.

Furthermore, the antennas Eᵢ of the array are synchronized together. To that end, the probe antenna transmits a synchronization signal at a reference time T₀. That signal has a frequency spectrum comprising at least the test frequencies. Hereafter, the operation will only be detailed for one test frequency f so as to facilitate the understanding thereof. This signal is received by each receiver of the antennas Eᵢ at moment T₀+t_{S}(f)+tᵢ(f), i.e. after a propagation period t_{S}(f) of the synchronization signal for a frequency f between the probe and the target and a propagation period tᵢ(f) of the synchronization signal for a frequency f between the target and the receiver of the antenna Eᵢ.

Each antenna of the sparse array then transmits a wave at a moment T₀+t_{S}(f)+tᵢ(f)+T(f)−2tᵢ(f)+k·T_{f} with k an integer.

T(f) is a predefined period called increase period so as to be sure that all of the receivers have received the synchronization wave at the frequency f. T is defined such that T(f)−2tᵢ(f)>0 for all of the antennas Eᵢ of the array. According to one alternative, the period T is unique for all of the test frequencies.

T_{f} is the period corresponding to the transmission frequency f. For example, tᵢ is measured with sufficient precision, in this case k=0. According to another example, tᵢ cannot be measured with sufficient precision, in which case one measures the phase deviation at the frequency f between the signal transmitted by the antenna Eᵢ and the wave backscattered by the target and received by the antenna Eᵢ, which is equal to the travel time tᵢ modulo the period T_{f}.

Each radiofrequency wave transmitted at a selected favored transmission frequency f by an antenna Eᵢ of the sparse array reaches the target at the end of a time period Tᵢ, depending on the frequency f, i.e. at a moment T₀+t_{S}(f)+T(f)+k·T_{f}. Thus, all of the waves reach the target at the same time so as to obtain a coherent addition of the signals on the target for each selected favored transmission frequency.

According to another embodiment of the method, step 118 is carried out in parallel with or before step 114 for choosing at least one favored frequency.

In that case, the selected favored transmission frequency or frequencies are, for example, those that meet the expectation of the maximum of a predetermined function depending on the values representative of the amplitude of the waves scattered by the target 12 for several combinations of frequencies as well as times tᵢ.

For example, the test radiofrequency wave has a frequency spectrum comprising two frequencies f₁ and f₂. Each receiver Rᵢ receives one of the radiofrequency waves scattered by the target in response to the test radiofrequency wave. The values representative of the amplitude of these scattered waves on each receiver Rᵢ are denoted Uᵢ₁ and Uᵢ₂ for frequencies f₁ and f₂. The selection unit 50 computes, for each frequency f₁ and f₂, a predetermined function

$$H ( {f}_{j} ) = {\sum }_{i}^{ } {h}_{i} \times {U}_{ij}$$

where hᵢ is a predetermined weight coefficient of the frequency fᵢ. The weight coefficient hᵢ depends on the travel time tᵢ of the scattered radiofrequency wave between the target 12 and the antenna Eᵢ of the array. The favored transmission frequency selected for the antennas Eᵢ of the array is the frequency for which the function G is maximal.

For example, if the travel time at the frequency f is shorter for the receiver R₁, which is therefore closer than the receiver R₂ to the target 12, the link budget, i.e. the quality of the link, is then more favorable for the antenna E₁ than for the antenna E₂ at the frequency f. Thus, the amplitude of the signal received at the frequency f will be paramount for the antenna E₁. Consequently, the function H will be weighted to take that into account.

The device and the method according to the invention make it possible to identify the most effective frequencies (residence, harmonic detection, favorable orientation of the target) and transmit in frequency coherence. The choice of the optimal frequency is made by analyzing the level of the power received by the various antennas of the sparse array.

Furthermore, they make it possible to use the available antennas of the sparse array without prejudging their position relative to the target.

1-10. (canceled)

11. A method for neutralizing a target, comprising the following steps:
the transmission by a probe antenna toward the target of a test signal comprising at least one test radiofrequency wave and having a frequency spectrum comprising at least two distinct test frequencies;
reception by an array of at least two antennas (Eᵢ) of a plurality of waves scattered by the target in response to the test signal, each antenna of the array receiving at least one wave scattered by the target;
said method being characterized in that it comprises at least the following steps:
measuring a representative value of the amplitude of the waves scattered by the target as a function of the transmission test frequencies of the radiofrequency waves;
choosing, for each antenna (Eᵢ) of the array, at least one favored transmission frequency as a function of the representative value of the amplitude of the scattered waves; and
transmitting, by each antenna (Eᵢ) of the array, at least one radiofrequency wave toward the target at a minimum of one favored frequency chosen beforehand for that antenna with a phase ensuring the coherent addition on the target of the radiofrequency waves transmitted by the antennas of the array.

12. The neutralization method according to claim 11, characterized in that it comprises a measuring step for each antenna (Eᵢ) of the array receiving a scattered radiofrequency wave, to measure the travel time (tᵢ) of the scattered radiofrequency wave between the target and the antenna (Eᵢ) of the array.

13. The neutralization method according to claim 12, characterized in that each antenna (Eᵢ) of the array is synchronized with the probe antenna and in that it transmits, toward the target, the radiofrequency wave at a defined moment as a function of the measured travel time of the scattered radiofrequency wave between the target and the antenna (Eᵢ) of the array.

14. The neutralization method according to claim 13, characterized in that it comprises a step for transmission by the probe antenna of a synchronization signal and a step for reception of that synchronization signal by each antenna (Eᵢ) of the array, which synchronizes itself on said synchronization signal.

15. The neutralization method according to claim 11, characterized in that the selected favored transmission frequency or frequencies are those whereof the representative value of the amplitude is the highest among the scattered radiofrequency waves received by all of the antennas (Eᵢ) in the array and in that the or each selected frequency for the transmission of a radiofrequency wave by the antennas of the array are shared by all of the antennas (Eᵢ) of the array.

16. The neutralization method according claim 11, characterized in that the selected favored transmission frequency or frequencies for the antenna (Eᵢ) are those whereof the value representative of the amplitude is highest among the scattered radiofrequency waves for each antenna of the array.

17. The neutralization method according to claim 11, characterized in that the selected favored transmission frequency or frequencies are those that meet the expectation of the maximum of a predetermined function depending on the values representative of the amplitude of the waves scattered by the target for several frequency combinations.

18. The neutralization method according to claim 12, characterized in that the selected favored transmission frequency or frequencies are those that meet the expectation of the maximum of a predetermined function depending on the values representative of the amplitude of the waves scattered by the target for several frequency combinations.

19. The neutralization method according to claim 18, characterized in that the predetermined function depends on the travel time (tᵢ) of the scattered radiofrequency wave between the target and the antenna (Eᵢ) of the array.

20. A device for neutralizing a target comprising:
a probe antenna, adapted to transmit, toward the target, a test signal comprising at least one test radiofrequency wave and having a frequency spectrum comprising at least two distinct test frequencies,
an array of at least two antennas (Eᵢ), each adapted to receive at least one radiofrequency wave scattered by the target in response to the test signal and to transmit at least one radiofrequency wave toward the target,
the device being characterized in that:
each antenna (Eᵢ) of the array comprises means (Tᵢ) for measuring the value representative of the amplitude of the waves scattered by the target as a function of the transmission test frequencies of the radiofrequency wave;
the device comprises a unit (50) for selecting at least one favored transmission frequency, for each antenna (Eᵢ) of the array, as a function of the value representative of the amplitude of the scattered waves;
each antenna (Eᵢ) of the array is capable of transmitting a radiofrequency wave toward the target at a minimum of one favored frequency chosen beforehand for that antenna with a phase ensuring the coherent addition on the target of the radiofrequency waves transmitted by the antennas of the array; and
in that the device is adapted to implement the method according to claim 11.

21. The neutralization device according to claim 20, characterized in that the antenna (Eᵢ) array comprises the probe antenna, the probe antenna being adapted to receive a radiofrequency wave scattered by the target.
